(19) United States
(12) Patent Application Publication
(10) Pub. No.: US 2006/0068673 A1
(43) Pub. Date: Mar. 30, 2006

(54) Synthetic nonwoven wiping fabric

(76) Inventors: Frank Goene, Veenendaal (NL); Mirelle van Rekum, Arnhem (NL); Diane Ellis, Cary, NC (US); Richard Halpin, Holly Springs, NC (US); Michael Putnam, Fuquay-Varina, NC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/237,239

(22) Filed: Sep. 28, 2005

Related U.S. Application Data
(60) Provisional application No. 60/613,771, filed on Sep. 28, 2004.
(60) Provisional application No. 60/613,673, filed on Sep. 28, 2004.

(51) Int. Cl. D04H 1/00; D04H 1/54; D04H 3/14; B32B 5/26

(52) U.S. Cl. 442/409; 442/415; 442/414; 442/411; 442/35; 28/104

(57) ABSTRACT

A 100% synthetic nonwoven wipe fabric and associated methods of manufacturing the same are presented. The 100% synthetic nonwoven fabric includes a fibrous blend of hydrophilic polypropylene and polyester. The fibrous blend comprises at least about 20 percent by weight hydrophilic polypropylene and in some embodiments at least about 40 percent by weight hydrophilic polypropylene.

### CROSS-REFERENCE TO RELATED APPLICATION

This application claims priority from U.S. Provisional Application Ser. No. 60/613,771, filed Sep. 28, 2004, and U.S. Provisional Application Ser. No. 60/613,673, filed Sep. 28, 2004, the disclosures of which are incorporated herein by reference.

### TECHNICAL FIELD

The present invention relates generally to nonwoven wipe fabrics, and more particularly, to a 100% synthetic nonwoven wipe fabric and associated methods for making the wipe fabric.

### BACKGROUND OF THE INVENTION

Nonwoven fabrics are suitable for use in a wide variety of applications where the efficiency with which the fabrics can be manufactured provides a significant economic advantage for these fabrics versus traditional textiles. Due to advancements in manufacturing procedures and improvements in fabric compositions, over the years, nonwoven fabrics have been utilized in many markets, including but not limited to disposable absorbent articles, such as diapers, feminine hygiene products, and incontinence garments, wipes, including household, hygienic, and food service wipes, meat packaging pads, automotive fabrics, medical fabrics, outdoor fabrics, and protective garments.

Nonwoven fabrics comprising a viscose rayon fiber blend have been particularly preferred due to the many desirable properties of the cellulosic based fiber. Viscose rayon, similar to other natural cellulosic fibers, is a versatile fiber. Rayon fabrics are breathable and comfortable, have an excellent hand and drape, and exhibit superb absorbency and dry strength. The aforementioned fiber characteristics of viscose rayon make this fiber especially suitable for nonwoven baby wipe substrates. Frequently, a strength imparting fiber, such as polyester or polypropylene, is blended with rayon to optimize the performance of a baby wipe substrate. Examples of nonwoven wipe fabrics that include rayon and a synthetic fiber are taught in U.S. Pat. No. 6,361,784, entitled “Soft, Flexible Disposable Wipe with Embossing”, issued on Mar. 26, 2002, in the name of inventors Brennan et al. U.S. Pat. No. 5,292,581, and “Wet Wipe”, issued on Mar. 8, 1994, in the name of inventors Viazmensky.

It has originally been the trend with those skilled in the art to incorporate cellulosic or viscose fiber in those nonwoven fabrics that require softness and an absorbency performance, but due to new developments, it has been learned that cellulosic or viscose fibers are no longer required to acquire a nonwoven fabric with an equivalent performance. Due to the increasing cost of cellulosic/viscose fiber and the undesirable odor often associated with viscose fiber in a wet state, a need has arisen to replace the cellulosic or viscose fibrous constituents with an alternative fiber that is comparable in its characteristics.

### SUMMARY OF THE INVENTION

The present invention is directed to a 100% synthetic nonwoven wipe fabric and associated methods of manufacturing the wipe fabric. The 100% synthetic nonwoven wipe fabric of the present invention will typically exhibit physical attributes similar to those physical attributes often associated with a cellulosic fiber blend wipe fabric.

In accordance with one embodiment of the present invention, a 100% synthetic nonwoven wipe fabric is formed from hydrophilic polypropylene and polyester staple fiber constituents. In one embodiment the wipe fabric is at least about 20 percent by weight hydrophilic polypropylene and in an alternate embodiment the wipe is at least about 40 percent by weight hydrophilic polypropylene. The percentage of hydrophilic polypropylene will typically be dictated by the end use application of the wipe fabric.

Manufacture of a nonwoven fabric embodying the principles of the present invention is initiated by providing a batt or layer of fibrous components. The fibrous batt is comprised of finite-length staple fibers, or can be essentially continuous filaments selected from synthetic compositions, of homogeneous or mixed fiber length. Synthetic fibers, which may also be blended in whole or part, include thermoplastic and thermoset polymers. Thermoplastic polymers suitable for use include polyolefins, polyamides and polyesters. The thermoplastic polymers may be further selected from homopolymers; copolymers, conjugates and other derivatives including those thermoplastic polymers having incorporated melt additives or surface-active agents. Staple lengths are selected in the range of 0.25 inch to 8 inches, the range of 1 to 3 inches being preferred and the fiber denier selected in the range of 1 to 15, the range of 2 to 6 denier being preferred for general applications. The profile of the fiber is not a limitation to the applicability of the present invention.

A method of making the nonwoven wipe further comprises the steps of providing a precursor web, which is subjected to hydroentangling. U.S. Pat. No. 3,485,706, issued to Evans, discloses processes for effecting hydroentanglement of nonwoven fabrics. More recently, hydroentanglement techniques have been developed which impart raised portions to the entangled fabric by effecting hydroentanglement on foraminous forming surface, such as a three-dimensional image transfer device. Such three-dimensional image transfer devices are disclosed in U.S. Pat. No. 5,098,764, hereby incorporated by reference, with the use of such image transfer devices being desirable for providing a fabric with enhanced physical properties as well as having a pleasing appearance.

The entangled nonwoven wipe of the present invention utilizes a hydrophilic polypropylene as the absorbent constituent of the fabric, and is therefore free of odors that are often associated with the wet state of viscose fibers. As such fabrics can be used as hygiene wipes that come in contact with the face, it is preferred that the fabric remain relatively odor-less prior to any desirable post-treatments. In addition to hygienic wipes, the nonwoven wipe fabric of the present invention is suitable for other wipe applications including homecare hard surface wipes, industrial and automotive wipes, as well as food service or hospitality wipes.

It is in the purview of the present invention to adjust the content of hydrophilic polypropylene constituent in the nonwoven fabric in order to influence the saturation time of the fabric. A lower content of hydrophilic polypropylene decreases the saturation time imparting a degree of buoyancy to the fabric that is beneficial to some end-use applications, including food service wipes. Food service wipes are often left in bucket s of cleaning solution between uses and tend to sink to the bottom of the bucket before being retrieved. Increased buoyancy in a food service wipe eases the cleaning process since the wipe remains afloat between short cleaning intervals. Further, in light of the performance characteristics, the nonwoven fabric of the present invention is also suitable for other end uses where strength and absorbency is required, such as diaper, fem-care, and incontinent garment components, as well as absorbent pads utilized in the meat packaging industry.

Thus, the present invention provides for a 100% synthetic nonwoven wipe fabric formed from hydrophilic polypropylene and polyester staple fiber constituents. The 100% synthetic nonwoven wipe fabric of the present invention will typically exhibit physical attributes similar to those physical attributes often associated with a cellulosic fiber blend wipe fabric. Thus, the resulting 100% synthetic fabric is less expensive to produce than cellulosic/viscose fiber and does the result in the undesirable odor often associated with viscose fiber in a wet state. In addition, the resulting fabric of the present invention is characteristically high-strength, highly durable and can be implemented in a wide-variety of wiping applications.

Other features and advantages of the present invention will become readily apparent from the following detailed description, the accompanying drawings, and the appended claims.

### BRIEF DESCRIPTION OF THE DRAWINGS

FIG. 1 is a diagrammatic view of an apparatus for manufacturing a durable 100% synthetic nonwoven fabric, embodying the principles of the present invention.

### DETAILED DESCRIPTION OF THE INVENTION

While the present invention is susceptible of embodiment in various forms, there is shown in the drawings, and will hereinafter be described, a presently preferred embodiment of the invention, with the understanding that the present disclosure is to be considered as an exemplification of the invention, and is not intended to limit the invention to the specific embodiment illustrated.

The 100% Synthetic Wipe Fabric

The present invention provides for a nonwoven wipe fabric that includes 100 percent (100%) synthetic fibers and includes hydrophilic polypropylene and polyester. As such, the 100% synthetic nonwoven wipe fabric of the present invention will typically exhibit physical attributes that are comparable to those physical attributes often associated with a cellulosic or viscose fiber blend wipe fabric. In one embodiment, the nonwoven wipe fabric is formed of a carded staple length fiber blend of 50% hydrophilic polypropylene and 50% polyester. Alternatively, the nonwoven fabric wipe may be formed from continuous filament fibers. The wipe fabric may comprise less than 50% polypropylene; however, for an optimal performance, it is preferred that the nonwoven wipe of the present invention comprise at least 20% by weight hydrophilic polypropylene.

In accordance with the present invention, the polypropylene fibrous components of the wipe are typically imparted with a hydrophilic performance by way of a melt additive that is incorporated into the master batch or optionally incorporated during the extrusion process at a level of about 2% to about 3% by weight. The preferred additive used to impart a permanent hydrophilic performance to the polypropylene is a blend of polyoxy alkylene derivatives made commercially available by Cognis of Düsseldorf, Germany as Standapol® 1480 (Standapol is a registered trademark of Standard Chemical Products, Inc.).

Fibrous polyester components used in the fabric wipe of the present invention include Polyethylene Terephthalate Polyester (PETP), available from Wellman Incorporated of Shrewsbury, N.J., as well as other thermoplastic polyesters.

Additional thermoplastic polymers that may be incorporated into the wipe include polyolefins, polyamides and polyesters. The thermoplastic polymers may be further selected from homopolymers; copolymers, conjugates and other derivatives including those thermoplastic polymers having incorporated melt additives or surface-active agents.

In those embodiment of the invention in which the hydrophilic polypropylene and the polyester fibers have staple lengths the lengths may be in the range of about 0.635 centimeters (cm) to about 20.32 cm, the range of about 2.54 cm to about 10.16 being preferred.

In addition, the fiber denier is typically in the range of about 1 to about 15, the range of about 2 to about 6 denier being preferred for general applications. The profile of the fiber is not a limitation to the applicability of the present invention.

The 100 percent synthetic nonwoven wipe fabric of the present invention may also include a support layer or scrim formed from any suitable synthetic material, including, but not limited to, synthetic wovens, synthetic knits, open mesh synthetic scrims, and/or synthetic nonwoven fabrics, which exhibit low elongation performance. Particular nonwoven fabrics of particular benefit are synthetic spunbond fabrics. Further, the present invention may incorporate nano-denier fibers and/or nano-denier filaments into the fibrous matrix. Use of nano-denier fibers and/or filaments will typically provide for an increase in fabric softness and strength.

Methods of Manufacturing 100% Synthetic Nonwoven Wipe Fabric

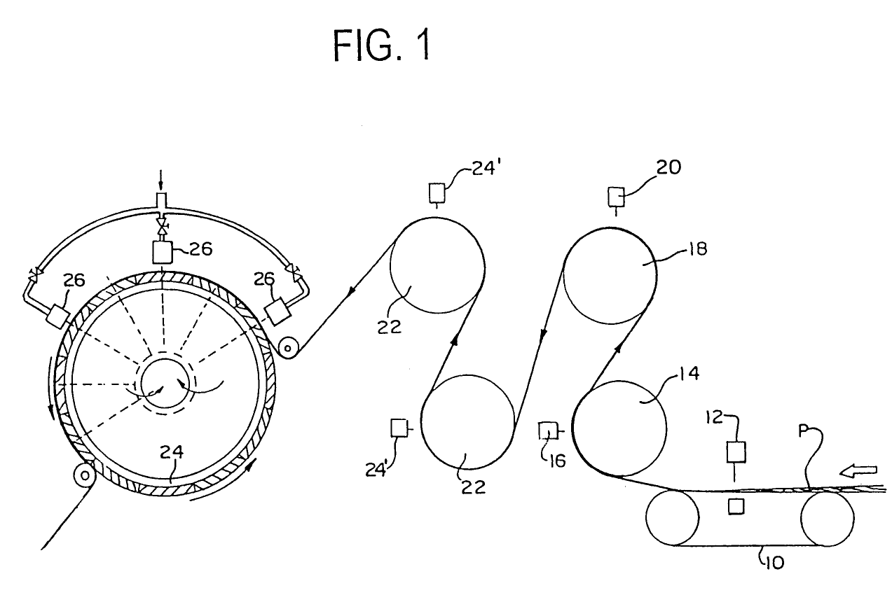

With reference to FIG. 1, therein is illustrated an apparatus for practicing the present method for forming a viscose-free 100% synthetic nonwoven fabric. The fabric is formed from a fibrous matrix, which typically comprises staple length fibers, but may comprise substantially continuous filaments. The fibrous matrix is preferably carded and optionally cross-lapped to form a fibrous batt with 100% cross-lapped fibers, that is, all of the fibers of the web have been formed by cross-lapping a carded web so that the fibers are oriented at an angle relative to the machine direction of the resultant web, which is designated F. U.S. Pat. No. 5,475,903, entitled, “Composite Nonwoven Fabric and Method” issued Dec. 19, 1995, in the name of inventor Collins, hereby incorporated by reference as if set forth fully herein, illustrates a web drafting apparatus.

Optionally, a support layer or scrim may be placed in face to face juxtaposition with the fibrous web prior to performing a pre-entanglement process. Alternately, the fibrous web can be pre-entangled first to form precursor web P, and subsequently, at least one support layer or scrim may be applied to the precursor web, and the composite construct optionally further hydroentangled with hydraulic jet manifolds, then imparted two or more surface projections by way of entanglement on a foraminous surface, preferably a three-dimensional image transfer device.

FIG. 1 illustrates a hydroentangling apparatus for forming nonwoven fabrics in accordance with the present invention. The apparatus includes a foraminous-forming surface in the form of belt 10 upon which the precursor web P is positioned for pre-entangling by entangling manifold 12. Pre-entangling of the precursor web, prior to optional three-dimensional imaging, is subsequently effected by movement of the web P sequentially over a drum 14 having a foraminous-forming surface, with entangling manifold 16 effecting entanglement of the web. Further entanglement of the web is effected on the foraminous forming surface of a drum 18 by entanglement manifold 20, with the web subsequently passed over successive foraminous drums 22, for successive entangling treatment by entangling manifolds 24, 24′.

Optionally, the nonwoven wipe fabric of the invention may be imparted with one or more raised portions. The entangling apparatus of FIG. 1 may further include a three-dimensional imaging drum 26 comprising a three-dimensional image transfer device for effecting imaging of the now-entangled precursor web. The image transfer device includes a moveable imaging surface which moves relative to a plurality of entangling manifolds 28 which act in cooperation with three-dimensional elements defined by the imaging surface of the image transfer device to effect imaging and patterning of the fabric being formed.

Once the web has been consolidated into a fabric by performing necessary hydroentanglement processing, the web may be optionally treated with one or more post treatments to provide the fabric with requisite performance characteristics.

Applications and End-Uses

The 100% synthetic nonwoven fabric embodying the principles of the present invention is especially suitable for various end-uses where strength, softness, and absorbency is required, including personal cleansing wipe articles, such as baby wipes, home care wipe applications, food service/hospitality wipes. Additionally the nonwoven fabric of the present invention is well suited for automotive or industrial wipes, in which the end use article may be a dry or wet hand held wipe, utilized in a mitt formation or in combination with a cleaning implement capable of retaining the cleaning article. Further, absorbent articles, such as diapers, fem-care products, and incontinent garment components, may benefit from the hydrophilic fabric construct, as well as absorbent pads utilized in the meat packaging industry.

The fabric is suitable for dispensing from a tub of stacked wipes, folded wipes, or for dispensing as “pop-up” wipes, in which the wipes are stored in the tub as a perforated continuous roll. In such a dispensing configuration, upon pulling a wipe out of the tub, an edge of the next wipe is presented for easy dispensing. The wipes of the present invention can be folded in any of various known folding patterns, such as C-folding, but is preferably Z-folded. A Z-folded configuration enables a folded stack of wipes to be interleaved with overlapping portions. The wipes may be packaged in various convenient forms, whereby the method of packaging is not meant to be a limitation of the present invention.

### EXAMPLES

Example 1 includes a carded and hydroentangled 48 grams per square meter (gsm) fibrous web having 50% by weight of 1.7 dtex, 38 mm cut-length, wettable, polypropylene made commercially available by FiberVisions (Varde, Denmark). The polypropylene additionally includes a melt additive, which is 2% by weight, Standapol® 1480 from Cognis (Düsseldorf, Germany) and 50% by weight of 1.7 dtex, 38 mm cut-length, Wellman type 203 (merge number 69929) polyester.

The hydroentangled web of Example 1 is manufactured by first subjecting the web to a pre-entangling step and further entangling the web upon an image transfer device, whereby the web is consolidated and imparted with raised portions. The physical properties of Example 1 are found in Table 1.

To compare physical properties to a “standard” wet wipe currently used in baby care, the physical data of Example 1 was evaluated against Comparative Example 1.

Comparative Example 1 includes a 55 gsm carded and hydroentangled fibrous web having 65% by weight of 1.7 dtex, 38 mm cut-length, Rayon Lenzesa made type 71000433 commercially available by Lenzing AG (Lenzing, Austria) and 35% by weight of 1.7 dtex, 38 mm cut length polyester type Eastlon SN 5530 made commercially available by Far Eastern Textile (Taipei, Taiwan).

The hydroentangled web of Comparative Example 1 was manufactured in the same process as Example 1. The physical properties of Comparative Example 1 are also found in Table 1.

TABLE 1

| | Example 1 | Comparative Example 1 |
|---|---|---|
| | 50% PP/50% PET | 65% Rayon/35% PET |
| Weight (gsm) | 48 | 55 |
| Thickness (4 ply) | 2.1 | 2.2 |
| Tensile L (N) | 59.3 | 56.2 |
| Elongation L (%) | 35.6 | 25.4 |
| Cross (N) | 13.4 | 8.4 |
| Cross @ 2 N (%) | 82.8 | 62.5 |
| Elongation CD (%) | 231.2 | 160.5 |
| Absorption | 1078 | 1142 |
| Sinking time (s) | 2.1 | 2 |

As shown from Table 1, the exemplary 100% nonwoven fabric has an about a 13 percent decrease in weight compared to a conventional cellulosic or viscose fiber fabric, an about 40 percent increase in elongation, an about 60 percent increase in cross (N), an about 32 percent increase in cross at 2N percentage, an about 44 percent increase in elongation CD percentage, while only exhibiting an about 5% decrease in absorption.

Testing Procedures

The sinking time is measured according to test method American Society of Test Methods (ASTM) 1015:

A full width sample is folded along the long direction into 4 sections. A number of strips 7.5 cm wide (any length) are cut from the folded sample. A weight of 5 grams of strips is measured, stacked on top of one another, rolled up, and inserted into a wire basket. The basket is dropped onto the water source from a height of no more than 1-1.5 cm and the time it takes for the basket to completely submerge into the water is recorded.

The absorption capacity is measured according to test method ASTM 1016:

A full width sample is folded along the long direction into 4 sections. A number of strips 7.5 cm wide (any length) are cut from the folded sample. A weight of 5 grams of strips is measured and recorded as weight A. The strips are stacked on top of one another, rolled up, and inserted into a wire basket. The basket is placed in the water and allowed to sink and remain submerged for at least 10 seconds. After 10 seconds, the basket is removed from the water and allowed to drain for an additional 10 seconds. The drained sample is placed on a tarred watch glass and the weight recorded as weight B. The following equation is used to calculate the absorbency capacity: Absorbent capacity=(B−A+3)/A×100% (3=weight of basket).

Thus, the present invention provides for a 100% synthetic nonwoven wipe fabric formed from hydrophilic polypropylene and polyester staple fiber constituents. The 100% synthetic nonwoven wipe fabric of the present invention will typically exhibit physical attributes similar to those physical attributes often associated with a cellulosic fiber blend wipe fabric. Thus, the resulting 100% synthetic fabric is less expensive to produce than cellulosic/viscose fiber and does the result in the undesirable odor often associated with viscose fiber in a wet state. In addition, the resulting fabric of the present invention is characteristically high-strength, highly durable and can be implemented in a wide-variety of wiping applications.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A nonwoven wipe, the wipe comprising:
100 percent synthetic fibers including a fibrous blend of hydrophilic polypropylene and polyester,
wherein the fibrous blend comprises at least about 20 percent by weight hydrophilic polypropylene.

2. The wipe of claim 1, wherein the 100 percent synthetic fibers are further defined as carded staple fibers.

3. The wipe of claim 1, wherein the 100 percent synthetic fibers are further defined as continuous filament fibers.

4. The wipe of claim 2, wherein the 100 percent synthetic fibers have a staple length in the range of about 0.635 centimeters (cm) to about 20.32 cm.

5. The wipe of claim 2, wherein the staple fibers have a staple length in the range of about 2.54 cm to about 10.16 cm.

6. The wipe of claim 1, wherein the 100 synthetic fibers are further defined as having fiber denier in the range of 1 to about 15.

7. The wipe of claim 1, wherein the 100 synthetic fibers are further defined as having fiber denier in the range of about 2 to about 6.

8. The wipe of claim 1, wherein the fibrous blend further comprises about 50 percent by weight hydrophilic polypropylene and about 50 percent by weight polyester.

9. The wipe of claim 1, wherein the hydrophilic polypropylene further comprises a melt additive.

10. The wipe of claim 9, wherein the melt additive is further defined as a blend of polyoxy alkylene derivatives.

11. The wipe of claim 10, wherein the blend of polyoxy alkylene derivatives is about 2 percent to about 3 percent by weight of the hydrophilic polypropylene.

12. The wipe of claim 1, further comprising a support layer.

13. The wipe of claim 12, wherein the support layer is further defined as a scrim.

14. The method of claim 13, wherein the support layer is formed from a synthetic material chosen from the group consisting of synthetic wovens, synthetic knits, open mesh synthetic materials and synthetic nonwoven fabrics.

15. The wipe of claim 1, wherein the wipe is a hygiene wipe.

16. The wipe of claim 1, wherein the fibrous blend comprises at least 40% by weight hydrophilic polypropylene.

17. A method of manufacturing a nonwoven wipe fabric, the method comprising the steps of:
providing a fibrous matrix of 100 percent synthetic nonwoven fibers;
carding the fibrous matrix to form a 100 percent synthetic fibrous pre-cursor web;
pre-entangling the fibrous pre-cursor web on a foraminous surface and
hydroentangling the fibrous pre-cursor web to form a 100 percent synthetic nonwoven fabric.

18. The method of claim 17, further comprising the step of cross-lapping the fibrous precursor web to form a 100 percent cross-lapped fibrous batt.

19. The method of claim 17, further comprising the step of providing a support layer that is juxtaposed in a face-to-face relationship with the fibrous pre-cursor web prior to pre-entangling the fibrous web.

20. The method of claim 17, further comprising the step of providing a support layer that is juxtaposed in a face-to-face relationship with the fibrous pre-cursor web after pre-entangling the fibrous pre-cursor web and prior to hydroentangling the pre-cursor web.

21. The method of claim 17, further comprising the step of raising a portion of the fibrous pre-cursor web during hydroentanglement by subjecting the pre-cursor web to an image transfer device.

22. The method of claim 17, further comprising the step of treating the 100 percent synthetic nonwoven fabric with a post treatment composition.
